(19) United States
(12) Patent Application Publication
(10) Pub. No.: US 2024/0420160 A1
(43) Pub. Date: Dec. 19, 2024

(54) METHOD AND DEVICE FOR DEFINING CARBON EMISSION ACCOUNTING BOUNDARY OF POWER BATTERY RECYCLING

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Haijun Yu, Foshan, Guangdong (CN); Congguang Zhang, Foshan, Guangdong (CN); Yinghao Xie, Foshan, Guangdong (CN); Changdong Li, Foshan, Guangdong (CN)

(21) Appl. No.: 18/704,976

(22) PCT Filed: Jul. 28, 2022
(86) PCT No.: PCT/CN2022/108659

§ 371 Date: Apr. 26, 2024

(30) Foreign Application Priority Data
Oct. 27, 2021 (CN) 202111259413.8

(51) Int. Cl. G06Q 30/018; G06Q 10/30

(52) U.S. Cl. CPC G06Q 30/018; G06Q 10/30

(57) ABSTRACT

A method and device for defining a carbon emission accounting boundary for recycling of power batteries are provided. The method includes: setting an overall process flow range for the recycling of a decommissioned power battery; according to the overall process flow range, and in combination with an evaluation need corresponding to the carbon emissions accounting, generating a corresponding boundary; according to the boundary, outputting unit processes and an inventory structure corresponding to the recycling of the retired power battery.

### TECHNICAL FIELD

The disclosure relates to the field of power battery recycling, and in particular to a method and device for defining a carbon emission accounting boundary of power battery recycling.

### BACKGROUND ART

With the development of science and technology, the application of power batteries has become more and more extensive. The power battery contains a variety of metal elements, if improperly handled, which may cause safety hazards and environmental pollution, and is difficult to recycle. The current life cycle assessment (LCA) of power batteries generally includes the recycling of power batteries in the entire life cycle. However, in the existing technology, when evaluating the life cycle of retired power batteries or accounting for their carbon emissions, there is often a problem of ambiguous system boundaries. The output results obtained for the same evaluation need may be quite different, which has also led to errors in conclusions of some researches. And these theories are not realistic in the process of carbon emission accounting.

### SUMMARY

The disclosure provides a method and device for defining the carbon emission accounting boundary of power battery recycling to solve the technical problem of ambiguous system boundaries and improve the accuracy of life cycle assessment and carbon emission accounting of retired power batteries.

In order to solve the above technical problems, embodiments of the present disclosure provide a method for defining a carbon emission accounting boundary of power battery recycling, including:
setting an overall process flow range of retired power battery recycling;
according to the overall process flow range, combined with an evaluation need corresponding to the carbon emission accounting, generating a corresponding boundary;
according to the boundary, outputting unit processes and an inventory structure corresponding to the retired power battery recycling.

Further, the overall process flow range is a range formed by combination of one or more of the following processes: pre-plant treatment process, transportation process, waste treatment process, in-plant physical treatment process, in-plant chemical treatment process, product formation process and distribute and use process.

Further, the corresponding boundary is generated according to the overall process flow range in combination with the evaluation need corresponding to the carbon emission accounting, which specifically is:
when the evaluation need corresponding to the carbon emission accounting covers only waste treatment, a first boundary corresponding to the evaluation need is generated by combining the pre-treatment process, the transportation process, and the waste treatment process in the overall process flow range;
when the evaluation need corresponding to the carbon emission accounting covers copper and aluminum metals obtainment, plastic casings obtainment, or raw materials preparation for chemical extraction, a second boundary corresponding to the evaluation need is generated by combining the pre-treatment process, the transportation process, the waste treatment process and the in-plant physical process in the overall process flow range;
when the evaluation need corresponding to the carbon emission accounting covers metal elements recycling, supply of raw materials for preparation of precursors, or supply of raw materials for preparing cathode materials, a third boundary corresponding to the evaluation need by combining the pre-treatment process, the transportation process, the waste treatment process, the in-plant physical treatment process and the in-plant chemical treatment process in the overall process flow range;
when the evaluation need corresponding to the carbon emission accounting covers manufacture of regenerated batteries, a fourth boundary corresponding to the evaluation need is generated by combining the pre-treatment process, the transportation process, the waste treatment process, the in-plant physical treatment process, the in-plant chemical treatment process, and the product formation process in the overall process flow range;
when the evaluation need corresponding to carbon emission accounting covers manufacture of regenerated batteries and putting them on market, a fifth boundary corresponding to the evaluation need is generated by combining the pre-treatment process, the transportation process, the waste treatment process, the in-plant physical treatment process, the in-plant chemical treatment process, the product formation process and the distribution and use process in the overall process flow range.

Further, according to the boundary, the unit processes and the inventory structure corresponding to the recycling of the retired power battery are output, which are specifically:
when the boundary is the first boundary, outputting a first transportation process information and a waste treatment process information;
when the boundary is the second boundary, outputting a second transportation process information, a second waste treatment process information, and a second in-plant physical treatment process information;
when the boundary is the third boundary, outputting a third transportation process information, a third waste treatment process information, a third in-plant physical treatment process information, and a third in-plant chemical treatment process information;
when the boundary is the fourth boundary, outputting a fourth transportation process information, a fourth waste treatment process information, a fourth in-plant physical treatment process information, a fourth in-plant chemical treatment process information, and a fourth product formation process information;
when the boundary is the fifth boundary, outputting a fifth transportation process information, a fifth waste treatment process information, a fifth in-plant physical treatment process information, a fifth in-plant chemical treatment process information, a fifth product formation process information, and a fifth distribution and use process information.

Further, the transportation process information corresponding to the retired power battery includes the scope of transportation within and outside the plant, transportation means, fuel type, and fuel consumption per 100 kilometers: the waste treatment process information corresponding to the retired power battery includes a waste treatment method, a waste recycling method, a standardized waste discharge method, parameter information of required equipment and input-output logistics information.

Further, the in-plant physical treatment process information corresponding to the retired power battery includes the information on equipment for discharge, heat treatment, crushing, sorting, and mechanical disassembly processes, first data on input and output of materials and energy for each functional unit.

Further, the in-plant chemical treatment process information corresponding to the retired power battery includes equipment information for leaching, chemical purification, extraction purification, crystallization, liquid preparation, reaction, filtration and washing, drying, foreign matter separation, and high-temperature calcination processes, second data on input and output of materials and energy for each functional unit.

Further, the product formation process information corresponding to the retired power battery includes product package materials, packing materials, and pelleting program information.

Further, the distribution and use process information corresponding to the retired power battery includes product distribution and use logistics information and information on carbon emissions caused by the loading weight of the power battery.

Correspondingly, an embodiment of the present disclosure also provides a device for defining a carbon emission accounting boundary of power battery recycling, including a range setting unit, a boundary determination unit, and an information output unit: where,
the range setting unit sets the overall process flow range of the recycling of the retired power battery: the overall process flow range is a range formed by combination of one or more of the following processes: a pre-processing process, a transportation process, a waste treatment process, an in-plant physical treatment process, an in-plant chemical treatment process, a product formation process and a distribution and use process;
the boundary determination unit is configured to generate a corresponding boundary according to the overall process flow range and an evaluation need corresponding to the carbon emission accounting;
the information output unit is configured to output unit processes and inventory structure corresponding to the recycling of the retired power battery according to the boundary.

Compared with the prior art, the embodiments of the present disclosure have the following beneficial effects:

The present disclosure provides a method and device for defining a carbon emission accounting boundary for a power battery recycling. The defining method includes: setting an overall process flow range for the recycling of retired power battery: according to the overall process flow range, combined with an evaluation need corresponding to the carbon emission accounting, a corresponding boundary is generated: according to the boundary, unit process and an inventory structure corresponding to the recycling of the retired power battery are output. By defining the carbon emission accounting boundary, the present disclosure determines a clear and standardized system boundary compared to the prior art, improves the accuracy of the carbon emission accounting and a full life cycle assessment of retired power batteries, and is more suitable for practical applications.

### BRIEF DESCRIPTION OF DRAWINGS

FIG. 1 is a schematic flow chart of an embodiment of the method for defining the carbon emission accounting boundary of power battery recycling provided by the present disclosure.

FIG. 2 is a schematic structural diagram of an embodiment of the device for calculating the carbon emission accounting boundary for the power battery recycling provided by the present disclosure.

### DETAILED DESCRIPTION OF EMBODIMENTS

The technical solutions in the embodiments of the present disclosure will be clearly and completely described below in conjunction with the accompanying drawings in the embodiments of the present disclosure. Obviously, the described embodiments are only a part of the embodiments of the present disclosure, rather than all the embodiments. Based on the embodiments of the present disclosure, all other embodiments obtained by those of ordinary skill in the art without creative work shall fall within the protection scope of the present disclosure. Embodiment Example 1:

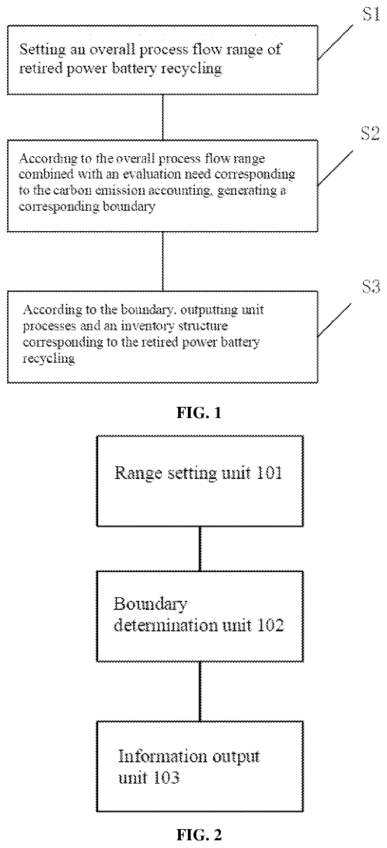

Please refer to FIG. 1, which is a method for defining a carbon emission accounting boundary of power battery recycling according to an embodiment of the present disclosure, including steps S1 to S3: wherein,
Step S1, setting an overall process flow range for the recycling of a retired power battery:

In this embodiment, the overall process flow range is formed by combination of one or more of the following processes: pre-plant treatment process, transportation process, waste treatment process, in-plant physical treatment process, and in-plant chemical treatment Process, product formation process and distribution and use process.

In this embodiment, the pre-plant treatment process includes the following steps:
confirming, registering, archiving, and back-upping accordingly the type of the retired power battery product to be picked up and the type of a corresponding vehicle loaded with the battery;
checking whether there is leakage of electricity or insulation failure, if yes, performing insulation treatment or safe discharging until the voltage is lower than 1.5V;
checking whether the electrolyte is leaking, cutting offing a leak source, collecting the electrolyte and eliminating risk of leakage by using a special anti-leakage packaging box or adopting effective anti-leakage measures;
checking whether there is a trace of fire or smoke: if there is, placing the batteries in isolation: carrying out packing and transportation after the danger is lifted, or unpacking inspection to eliminate the risk;
checking whether there are any signs of water immersion, determining the degree of safety risk of immersion, and performing air-dry or eliminating the risk;
checking the battery parameters such as battery temperature and voltage to determine whether they exceed the safety limit conditions specified by the manufacturer. If exceed the safety limit, placing the battery in isolation and subjecting it to packing and transportation after the danger is removed:

In this embodiment, the transportation process includes the following steps:
determining the transportation time, location, docking information, handover method and transportation plan;
adopting a transportation company with qualifications and rich experience in the transportation of dangerous goods;
installing fire and smoke detectors (a wireless connector is installed in the cab to monitor the condition of the vehicle), and turning on GPS to remotely monitor the condition of the vehicle;
developing emergency plans, strictly controlling vehicle loads, and communicating with vehicle transportation personnel at predetermined intervals.

In this embodiment, the in-plant physical treatment process includes the following steps:
after picking up, storing, dismantling, and reusing the retired power battery according to specific needs or business requirements. Among them, reusing includes echelon utilization and recycling;
after discharging, subjecting the battery to shell cutting, then wet crushing and sorting to obtain iron, copper, aluminum, carbon powder and a mixture of cathode and anode electrodes;
recycle the iron, copper, aluminum, and carbon powder, and subjecting the mixture of cathode and anode electrodes to pyrolysis;
according to different degrees of pyrolysis, carrying out crushing, screening, magnetic separation, dehydration or secondary combustion, preliminary dust removal, cooling, deacidification, bag dust removal and re-acid removal respectively to obtain a pyrolysis slag.

In this embodiment, the in-plant chemical treatment process is mainly to obtain valuable metals such as cobalt, nickel, lithium, and manganese through wet method or fire method.

In this embodiment, the product formation process includes: preparing cathode and anode electrodes materials, coating of the cathode and anode electrodes, sheeting of the cathode and anode electrodes, oven drying with the separator, winding, short circuit testing, shelling, rolling groove, filling electrolyte, formation, capacity grading and packaging to obtain a final battery product.

The distribution and use process includes delivering battery products to consumers or downstream customers through different logistics methods and sales channels.

In this embodiment, the waste treatment process includes the following step:
disposing solid, liquid and gaseous waste generated by each process in accordance with relevant waste treatment requirements and standards.
Step S2, generating a corresponding boundary according to the overall process flow range, combined with the evaluation need corresponding to the carbon emission accounting;

In this embodiment, the corresponding boundary is generated according to the overall process flow range and the evaluation need corresponding to carbon emission accounting, specifically:
when the evaluation need corresponding to the carbon emission accounting covers only waste treatment, generating a first boundary corresponding to the evaluation need by combining the pre-treatment process, the transportation process, and the waste treatment process in the overall process flow range;
when the evaluation need corresponding to the carbon emission accounting covers copper and aluminum metals obtainment, plastic casings obtainment, preparation of raw materials for chemical extraction, generating a second boundary corresponding to the evaluation need by combining the pre-treatment process, the transportation process, the waste treatment process and the in-plant physics in the overall process flow range;
when the evaluation need corresponding to the carbon emission accounting covers metal elements recycling, supply of raw materials for preparing precursors, or supply of raw materials for preparing cathode materials, generating the third boundary corresponding to the evaluation need by combining the pre-treatment process, the transportation process, the waste treatment process, the in-plant physical treatment process and the in-plant chemical treatment process in the overall process flow range;
when the evaluation need corresponding to the carbon emission accounting is manufacture of regenerated batteries, generating a fourth boundary corresponding to the evaluation need by combining the pre-treatment process, the transportation process, the waste treatment process, the in-plant physical treatment process, the in-plant chemical treatment process, and the product formation process in the overall process;
when the evaluation need corresponding to the carbon emission accounting covers manufacture of regenerated batteries and putting them on market, generating a fifth boundary corresponding to the evaluation need by combining the pre-treatment process, the transportation process, the waste treatment process, the in-plant physical treatment process, the in-plant chemical treatment process, the product formation process and the distribution and use process in the overall process flow range.
Step S3, according to the boundary, outputting unit processes and inventory structure corresponding to the recycling of the retired power battery.

In this embodiment, when the boundary is the first boundary, a first transportation process information and a waste treatment process information are output: wherein,
the transportation process information corresponding to the retired power battery includes the scope of transportation inside and outside the plant, transportation means, fuel type, and fuel consumption per 100 kilometers: the waste treatment process information corresponding to the retired power battery includes waste treatment method and waste recycling method, the standardized waste discharge method, the parameter information of the required equipment and the input-output logistics information.

When the boundary is the second boundary, a second transportation process information, a second waste treatment process information, and a second in-plant physical treatment process information are output: where,
the in-plant physical processing flow information corresponding to the retired power battery includes information on the equipment for discharge, heat treatment, crushing, sorting, and mechanical disassembly processes, first data on input and output of materials and energy for each functional unit.

When the boundary is the third boundary, a third transportation process information, a third waste treatment process information, a third in-plant physical treatment process information, and a third in-plant chemical treatment process information are output: where,
the in-plant chemical treatment process information corresponding to the retired power battery includes the information on the equipment for leaching, chemical purification, extraction purification, crystallization, liquid preparation, reaction, filtration and washing, drying, foreign matter separation, high-temperature calcination processes, second data on input and output of materials and energy for each functional unit.

When the boundary is the fourth boundary, a fourth transportation process information, a fourth waste treatment process information, a fourth in-plant physical treatment process information, a fourth in-plant chemical treatment process information, and a fourth product formation process information are output, where:
the product formation process information corresponding to the retired power battery includes product packaging materials, packing materials, and pelleting program information.

When the boundary is the fifth boundary, a fifth transportation process information, a fifth waste treatment process information, a fifth in-plant physical treatment process information, a fifth in-plant chemical treatment process information, a fifth product formation process information, and a fifth distribution and use process information are output, where,
the distribution and use process information corresponding to the retired power battery includes product distribution and use logistics information (this information is mainly determined based on the logistics model of new energy vehicles, such as the national standard “Building Carbon Emission Calculation Standard” issued by the Ministry of Housing and Urban-Rural Development (No. GB/T51366-2019) on the calculation method of transportation distribution, to determine the average transportation distance and average transportation weight of the product produced, that is, to determine the average ton*km value of the product, in addition to determining the vehicles types for the transportation, including 2 ton, 5 ton light vehicles, 10 ton heavy vehicles, 15 ton heavy vehicles, etc.) and information on carbon emissions caused by the loading weight of the power battery.

Correspondingly, referring to FIG. 2, which is a schematic structural diagram of a device for defining a carbon emission accounting boundary for power battery recycling according to an embodiment of the present disclosure, including a range setting unit 101, a boundary determination unit 102, and an information output unit 103: where,
the range setting unit 101 sets an overall process flow range for the recycling of retired power batteries: the overall process flow range is a range formed by combination of one or more of the following processes: a pre-treatment process, a transportation process, a waste treatment process, an in-plant physical treatment process, an in-plant chemical treatment process, a product formation process and a distribution and use process;
the boundary determination unit 102 is to generate a corresponding boundary according to the overall process flow range and the evaluation need corresponding to the carbon emission accounting;
the information output unit 103 is to output the unit processes and inventory structure corresponding to the recycling of the retired power battery according to the boundary.

Compared with the prior art, the embodiments of the present disclosure have the following beneficial effects:
the present disclosure provides a method and device for defining a carbon emission accounting boundary for recycling of power batteries. The defining method includes: setting an overall process flow range for the recycling of retired power battery: according to the overall process flow range, combined with the evaluation need corresponding to the carbon emission accounting, a corresponding boundary is generated: according to the boundary, the unit processes and inventory structure corresponding to the recycling of the retired power battery are output. By defining the carbon emission accounting boundary, the present disclosure determines a clear and standardized system boundary compared to the prior art, improves the accuracy of carbon emission accounting and the full life cycle assessment of retired power batteries, and is more suitable for practical applications.

### Embodiment Example 2

According to the method for defining the carbon emission accounting boundary of power battery recycling according to the present disclosure, an embodiment (Example 2) is also provided, which includes the following steps:
Step S1, setting an overall process flow range for the recycling of a retired power battery:

In this embodiment, the scope of the overall process flow includes seven processes in the full life cycle of a recycling technology of a retired power battery, namely, a pre-plant treatment process, a transportation process, a waste treatment process, an in-plant physical treatment process, an in-plant chemical treatment process, a product formation process and a distribution and use process.
Step S2, according to the overall process flow range, combined with an evaluation need corresponding to the carbon emission accounting, a corresponding boundary is generated:

In this embodiment, because it is for the evaluation of lithium iron phosphate cathode material products, a fourth boundary is selected, which includes a pre-treatment process, a transportation process, a waste treatment process, an in-plant physical treatment process, an in-plant chemical treatment process and a product formation process. The purpose corresponding to this boundary is to use recycled metal raw materials to prepare lithium iron phosphate cathode material products.
Step S3, according to the boundary, unit processes and an inventory structure corresponding to the recycling of the retired power battery are output.

In this embodiment, the transportation process within the boundary range only includes the transportation range outside the factory. Assuming that the average transportation distance of the retired batteries is 500 km, and a Xichai 4110 diesel vehicle is used for transportation, the average fuel consumption per 100 kilometers of this model is 12-14 liters: the waste treatment process includes treating, mixing, calcinating and other processes of the waste liquid, waste gas and solid waste, which will produce carbon-containing organic compounds mainly comprising Li element, CO₂, CO, ammonia, sulfide, ammonium hydrogen phosphate and sucrose, etc. The carbon-containing organic matter is mainly discharged in the form of gas, after being treated for harmless disposal according to environmental protection requirements. Wastewater is processed by a third-party service provider.

At the same time, it is also necessary to consider the in-plant physical treatment process of the waste batteries, such as the information on equipment for processes of discharging, heat treatment, crushing, sorting, mechanical disassembly, etc., data on input and output of materials and energy for each functional unit. It is also need to consider the equipment information of the chemical treatment process in the factory including leaching, chemical purification, extraction purification, crystallization, liquid preparation, reaction, filter washing, drying, foreign matter separation, high temperature calcination, etc., data on input and output of materials and energy for each functional unit, etc.;

According to statistics, on average, for every kWh of waste ternary lithium battery recycling, the materials that need to be input include:

| Material | Unit | Dosage |
|---|---|---|
| Sodium chloride | g | 67.5 |
| Water | kg | 83.1 |
| Sulfuric acid | kg | 1.27 |
| Bis(2-ethylhexyl) hydrogen | kg | 0.00394 |
| phosphate | | |
| 2-ethylhexyl phosphonic acid- | kg | 0.00145 |
| mono-2-ethylhexylester | | |
| Sulfonated kerosene | kg | 0.0137 |
| Sodium sulfide | kg | 0.0133 |
| Liquid alkali | kg | 0.884 |
| Aqueous Ammonia | kg | 0.0417 |

According to statistics, on average, for every kWh of waste ternary lithium battery recycling, the energy input required is 0.0186 kWh of electricity and 12 kg of steam.

According to statistics, on average, for every kWh of waste ternary lithium battery recycling, the produced emission list is shown in the following table:

| | Discharge | | Discharge |
|---|---|---|---|
| Discharge type | pollutant name | Unit | amount |
| Air pollutant | Dust | g | 0.238 |
| | Hydrogen | g | 0.0438 |
| | Fluoride | | |
| | Sulfuric acid mist | g | 0.0375 |
| | Hydrogen sulfide | g | 0.0229 |
| | Ammonia | g | 0.0859 |
| Water pollutant | Chemical Oxygen | g | 10.3 |
| | Demand | | |
| | Suspended solids | g | 124 |
| | Biological oxygen | g | 3.64 |
| | demand | | |
| | Nickel | g | 0.0475 |
| | Cobalt | g | 0.0438 |
| | Manganese | g | 0.0475 |
| | Lithium | g | 3.98 |
| | Ammonia | g | 0.596 |
| | nitrogen | | |

Compared with the prior art, the embodiments of the present disclosure have the following beneficial effects:
the embodiment of the present disclosure provides a method for defining the carbon emission accounting boundary of the recycling of a power battery. The defining method includes: setting an overall process flow range for the recycling of a retired power battery; according to the overall process flow range, combined with the evaluation need corresponding to the carbon emission accounting, a corresponding boundary is generated; according to the boundary, the unit processes and an inventory structure corresponding to the recycling of the retired power battery are output. By defining the carbon emission accounting boundary, the present disclosure determines a clear and standardized system boundary compared to the prior art, improves the accuracy of carbon emission accounting and the full life cycle assessment of retired power batteries, and is more suitable for practical applications.

The specific embodiments described above provide a further detailed description of the purpose, technical solutions and beneficial effects of the present disclosure. It should be understood that the above are only specific embodiments of the present disclosure and are not intended to limit the protection scope of the present disclosure. In particular, for those skilled in the art, any modification, equivalent replacement, improvement, etc. made within the spirit and principle of the present disclosure should be included in the protection scope of the present disclosure.

1. A method for defining a carbon emission accounting boundary of power battery recycling, comprising:
setting an overall process flow range for recycling of a retired power battery;
generating a corresponding boundary, according to the overall process flow range, combined with an evaluation need corresponding to the carbon emission accounting;
outputting, according to the boundary, unit processes and an inventory structure corresponding to the recycling of the retired power battery.

2. The method for defining the carbon emission accounting boundary of power battery recycling according to claim 1, wherein the overall process flow range is a range formed by combination of one or more of following processes: a pre-treatment process, a transportation process, a waste treatment process, an in-plant physical treatment process, an in-plant chemical treatment process, a product formation process and a distribution and use process.

3. The method for defining the carbon emission accounting boundary of power battery recycling according to claim 2, wherein generating the corresponding boundary according to the overall process flow range, combined with the evaluation need corresponding to the carbon emission accounting comprises:
when the evaluation need corresponding to the carbon emission accounting covers only waste treatment, generating a first boundary corresponding to the evaluation need by combining the pre-treatment process, the transportation process, and the waste treatment process in the overall process flow range;
when the evaluation need corresponding to the carbon emission accounting covers obtaining of copper and aluminum metals, obtaining of plastic casings, or preparation of raw materials for chemical extraction, generating a second boundary corresponding to the evaluation need by combining the pre-treatment process, the transportation process, the waste treatment process, and the in-plant physical treatment process in the overall process flow range;
when the evaluation need corresponding to the carbon emission accounting covers recycling of metal elements, supply of raw materials for preparing precursors, or supply of raw materials for preparing cathode materials, generating a third boundary corresponding to the evaluation need by combining the pre-treatment process, the transportation process, the waste treatment process, the in-plant physical treatment process and the in-plant chemical treatment process in the overall process flow range;
when the evaluation need corresponding to the carbon emission accounting covers manufacture of regenerated batteries, generating a fourth boundary corresponding to the evaluation need by combining the pre-treatment process, the transportation process, the waste treatment process, the in-plant physical treatment process, the in-plant chemical treatment process, and the product formation process in the overall process flow range; and
when the evaluation need corresponding to the carbon emission accounting covers manufacture of regenerated batteries and putting them on market, generating a fifth boundary corresponding to the evaluation need by combining the pre-treatment process, the transportation process, the waste treatment process, the in-plant physical treatment process, the in-plant chemical treatment process, the product formation process and the distribution and use process in the overall process flow range.

4. The method for defining the carbon emission accounting boundary of power battery recycling according to claim 3, wherein outputting according to the boundary the unit processes and the inventory structure corresponding to the recycling of the retired power battery comprises:
outputting a first transportation process information and a waste treatment process information when the boundary is the first boundary;
outputting a second transportation process information, a second waste treatment process information, and a second in-plant physical treatment process information when the boundary is the second boundary;
outputting a third transportation process information, a third waste treatment process information, a third in-plant physical treatment process information, and a third in-plant chemical treatment process information when the boundary is the third boundary;
outputting a fourth transportation process information, a fourth waste treatment process information, a fourth in-plant physical treatment process information, a fourth in-plant chemical treatment process information, and a fourth product formation process information when the boundary is the fourth boundary; and
outputting a fifth transportation process information, a fifth waste treatment process information, a fifth in-plant physical treatment process information, a fifth in-plant chemical treatment process information, a fifth product formation process information, and a fifth distribution and use process information when the boundary is the fifth boundary.

5. The method for defining the carbon emission accounting boundary of power battery recycling according to claim 4, wherein the transportation process information corresponding to the retired power battery comprises a scope of transportation within and outside a plant, transportation means, a fuel type, and fuel consumption per hundred kilometers; and the waste treatment process information corresponding to the retired power battery comprises a waste treatment method, a waste recycling method, a standardized waste discharge method, and parameter information of required equipment and input-output logistics information.

6. The method for defining the carbon emission accounting boundary of power battery recycling according to claim 4, wherein the in-plant physical treatment process information corresponding to the retired power battery comprises equipment information of discharge, heat treatment, crushing, sorting, and mechanical disassembly processes, and first data on input and output of materials and energy for each functional unit.

7. The method for defining the carbon emission accounting boundary of power battery recycling according to claim 4, wherein the in-plant chemical treatment process information corresponding to the retired power battery comprises the equipment information of leaching, chemical purification, extraction purification, crystallization, liquid preparation, reaction, filtration and washing, drying, foreign matter separation, and calcination processes, and second data on input and output of materials and energy for each functional unit.

8. The method for defining the carbon emission accounting boundary of power battery recycling according to claim 4, wherein the product formation process information corresponding to the retired power battery comprises product packaging materials, packing materials, and pelletizing program information.

9. The method for defining the carbon emission accounting boundary of power battery recycling according to claim 4, wherein the distribution and use process information corresponding to the retired power battery comprises product distribution and use logistics information and information on carbon emissions due to the power battery loading weight.

10. A device configured for defining a carbon emission accounting boundary of power battery recycling, comprising a range setting unit, a boundary determination unit and an information output unit: wherein,
the range setting unit is configured to set an overall process flow range of recycling of a retired power battery; the overall process flow range is a range formed by combination of one or more of following processes: a pre-treatment process, a transportation process, a waste treatment process, an in-plant physical treatment process, an in-plant chemical treatment process, a product formation process and a distribution and use process;
the boundary determination unit is configured to generate a corresponding boundary according to the overall process flow range, combined with an evaluation need corresponding to the carbon emission accounting; and
the information output unit is configured to output unit processes and an inventory structure corresponding to the recycling of the retired power battery according to the boundary.
